(19) United States
(12) Patent Application Publication
(10) Pub. No.: US 2014/0038674 A1
(43) Pub. Date: Feb. 6, 2014

(54) TWO-PHASE POWER-EFFICIENT ACTIVITY RECOGNITION SYSTEM FOR MOBILE DEVICES

(71) Applicant: SAMSUNG ELECTRONICS CO., LTD., Suwon (KR)

(72) Inventors: Vijay Srinivasan, San Jose, CA (US); Thomas Phan, San Jose, CA (US)

(21) Appl. No.: 13/902,683

(22) Filed: May 24, 2013

Related U.S. Application Data
(60) Provisional application No. 61/678,481, filed on Aug. 1, 2012.

(51) Int. Cl. H04W 52/02

(52) U.S. Cl. CPC H04W 52/0251
USPC 455/574

(57) ABSTRACT

An activity recognition system for an electronic device comprising at least one sensor and a two-phase activity recognition module. The sensors capture data relating to user activity. The activity recognition application module identifies a user activity based on data captured by the sensors, and dynamically controls power consumption of the activity recognition module based on the user activity identified.

### CROSS-REFERENCE TO RELATED APPLICATIONS

This application claims priority to U.S. Provisional Patent Application Ser. No. 61/678,481, filed on Aug. 1, 2012, which is incorporated herein by reference.

### TECHNICAL FIELD

One or more embodiments relate generally to activity recognition systems, and in particular a two-phase power-efficient activity recognition system for mobile devices.

### BACKGROUND

Mobile devices include sensors such as accelerometers for capturing a user's physical context. An activity recognition system of a mobile device identifies and classifies a user's activity (e.g., running, biking, driving, etc.) based on the user's physical context. Information relating to the user's activity may be provided to a context-driven mobile application running on the mobile device.

### SUMMARY

One embodiment provides an activity recognition system for an electronic device comprising at least one sensor and a two-phase activity recognition module. The sensors capture data relating to user activity. The two-phase activity recognition module identifies a user activity based on data captured by the sensors, and dynamically controls power consumption of the activity recognition module based on the user activity identified.

One embodiment provides a method for facilitating activity recognition in an electronic device. The method comprises capturing data relating to user activity using at least one sensor device, identifying a user activity based on data captured by the sensor devices, and dynamically controlling power consumption for activity recognition based on the user activity identified.

One embodiment provides a non-transitory computer-readable medium having instructions which when executed on a computer perform a method comprising capturing data relating to user activity using at least one sensor, identifying a user activity based on data captured by the sensors, and dynamically controlling power consumption for activity recognition module based on the user activity identified.

One embodiment provides an electronic device comprising at least one sensor and a two-phase activity recognition module. The sensors capture data relating to user activity. The two-phase activity recognition module identifies a user activity based on data captured by the sensors, and dynamically controls power consumption of the activity recognition module based on the user activity identified.

These and other aspects and advantages of one or more embodiments will become apparent from the following detailed description, which, when taken in conjunction with the drawings, illustrate by way of example the principles of one or more embodiments.

### BRIEF DESCRIPTION OF THE DRAWINGS

For a fuller understanding of the nature and advantages of one or more embodiments, as well as a preferred mode of use, reference should be made to the following detailed description read in conjunction with the accompanying drawings, in which:

FIG. 1 shows a block diagram of a mobile device, in accordance with an embodiment.

FIG. 2 is a graph illustrating the consumption of power over time for a mobile device, in accordance with an embodiment.

FIG. 3 shows a block diagram of the activity classifier module, in accordance with an embodiment.

FIG. 4A is a block diagram illustrating the two-phase activity recognition module, in accordance with an embodiment.

FIG. 4B illustrates an example flow chart for two-phase activity recognition in a mobile device, in accordance with an embodiment.

FIG. 5 is a high-level block diagram showing an information processing system comprising a computing system implementing an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to activity recognition systems, and in particular a two-phase power-efficient activity recognition system for mobile devices. One embodiment provides an activity recognition system for an electronic device comprising at least one sensor and a two-phase activity recognition module. The sensors capture data relating to user activity. The two-phase activity recognition module identifies a user activity based on data captured by the sensors, and dynamically controls power consumption of the activity recognition module based on the user activity identified.

One embodiment provides a method for facilitating activity recognition in an electronic device. The method comprises capturing data relating to user activity using at least one sensor device, identifying a user activity based on data captured by the sensor devices, and dynamically controlling power consumption for activity recognition based on the user activity identified.

One embodiment provides a non-transitory computer-readable medium having instructions which when executed on a computer perform a method comprising capturing data relating to user activity using at least one sensor, identifying a user activity based on data captured by the sensors, and dynamically controlling power consumption for activity recognition module based on the user activity identified.

One embodiment provides an electronic device comprising at least one sensor and a two-phase activity recognition module. The sensors capture data relating to user activity. The two-phase activity recognition module identifies a user activity based on data captured by the sensors, and controls power consumption of the activity recognition module based on the user activity identified.

Activity recognition in a mobile device consumes a lot of power. Much of the power consumption in a mobile device arises from keeping the mobile device awake to perform activity recognition. One or more embodiments provide a two-phase activity recognition system for reducing the amount of time the mobile device is kept awake to accurately respond to a query for user activity.

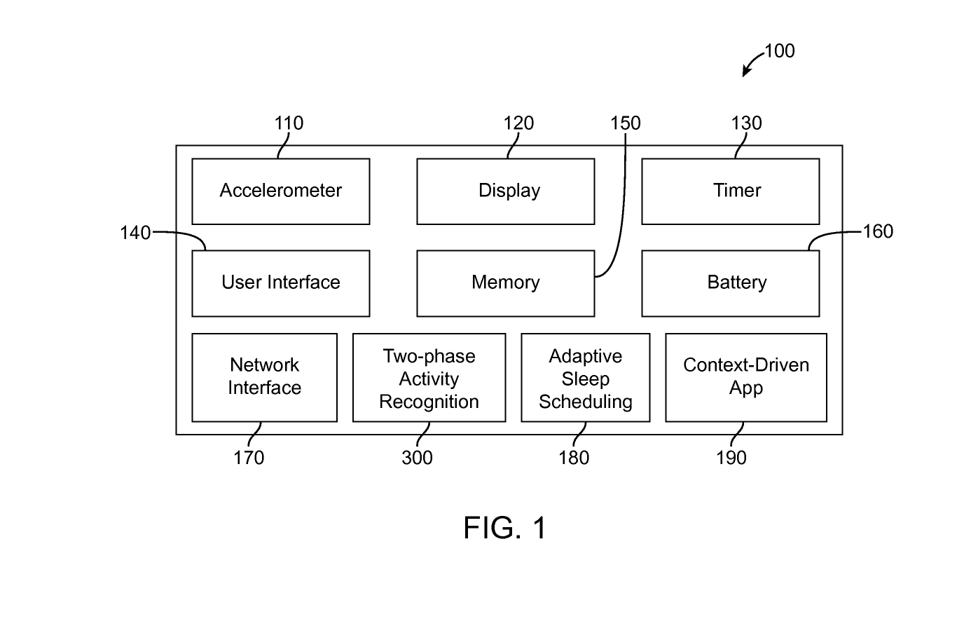

FIG. 1 shows a block diagram of a mobile device 100, in accordance with an embodiment. A mobile device 100 may be a mobile phone (e.g., a smart phone), a tablet, a laptop computer, etc. A mobile device 100 comprises a display 120 for displaying content. The mobile device 100 further comprises at least one sensor for capturing sensor data (i.e., inputs), such as an accelerometer 110 for measuring the physical acceleration experienced by the mobile device 100.

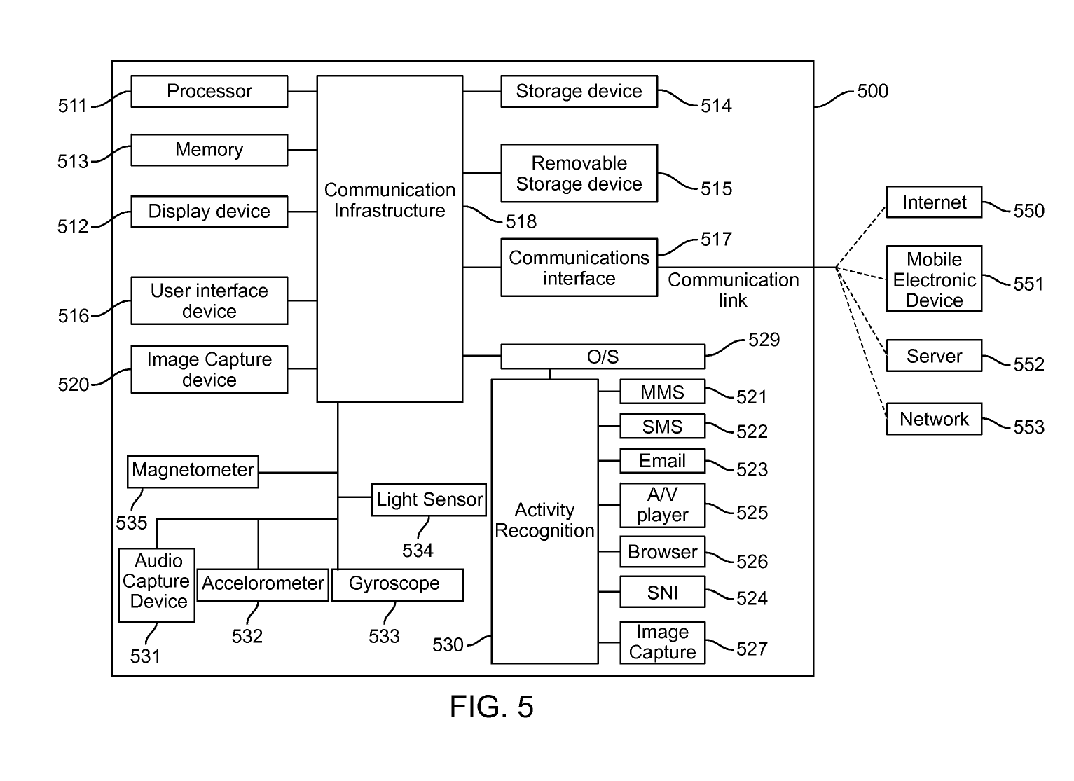

The mobile device 100 may include other sensors, such as an image capture device 520 (FIG. 5) for capturing video and/or images, an audio capture device 531 (FIG. 5) for capturing audio, a magnetometer 535 (FIG. 5) for measuring magnetic fields, a gyroscope 533 (FIG. 5) for measuring orientation, and a light sensor 534 (FIG. 5) for measuring lighting conditions of the environment surrounding the mobile device 100.

The mobile device 100 further comprises a two-phase activity recognition module 300 for activity recognition. Specifically, the activity recognition module 300 determines context information based on the sensor data captured by the sensors of the mobile device 100. The context information includes a current user activity of a user utilizing the mobile device 100. The context information is communicated to one or more context-driven applications 190 running on the mobile device, such as a fitness and health tracking application, or a context-based media playback application.

The mobile device 100 further comprises a user interface module 140 for generating a user interface through which a user may control the mobile device 100, such as controlling the playback of content on the mobile device 100.

The mobile device 100 further comprises a network interface module 170 for receiving data from, and sending data to, a content distributor or another mobile device 100 via a network (e.g., cellular network, IP network).

The mobile device 100 further comprises a re-chargeable battery unit 160 that supplies power for operating the mobile device 100.

The mobile device 100 further comprises a memory unit 150 for maintaining data, such as the context information.

In one embodiment, the mobile device 100 has at least two operating modes, such as an awake mode and a low-power sleep mode. In the awake mode, the mobile device 100 is fully operational and performs activity recognition. In the sleep mode, the mobile device 100 is in a low power mode to conserve the power supplied by the battery unit 160, and does not perform any activity recognition. As described in detail later herein, the mobile device 100 further comprises a timer unit 130 configured for switching the mobile device 100 between the sleep mode and the awake mode. In one embodiment, the mobile device 100 further comprises an adaptive sleep scheduling module 180 configured for dynamically adjusting the duration of a sleep mode.

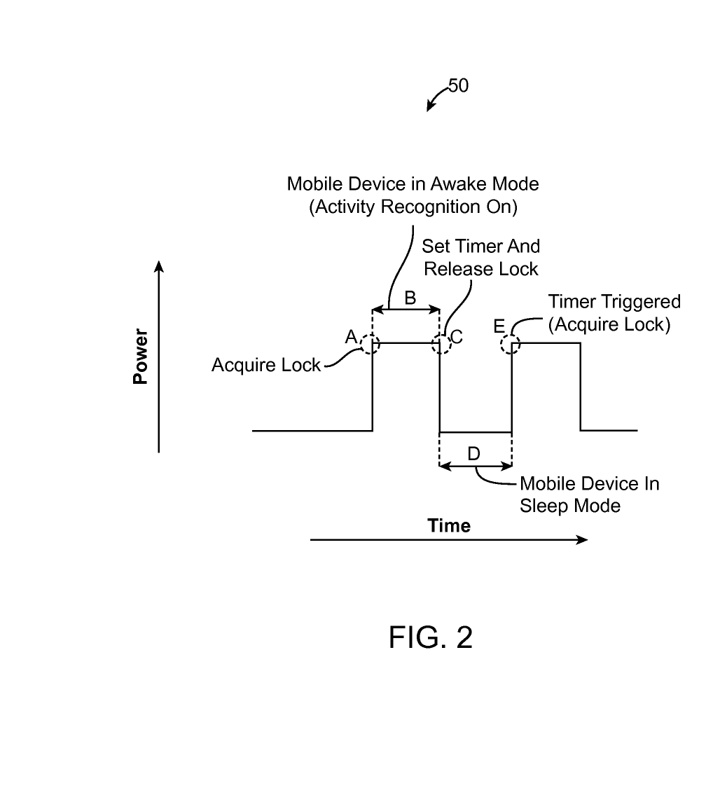

FIG. 2 is a graph 50 illustrating power consumption over time for a mobile device 100, in accordance with an embodiment. As shown in FIG. 2, the mobile device 100 cycles between the sleep mode and the awake mode to conserve power.

In FIG. 2, let points A and E of the graph 50 represent the mobile device 100 transitioning from the sleep mode to the awake mode. Let B represent an example duration of awake time for the awake mode. Let point C of the graph 50 represent the mobile device 100 transitioning from the awake mode to the sleep mode. Let D represent an example duration of sleep time for the sleep mode.

At points A and E, the timer unit 130 acquires a wake lock. The wake lock ensures that the two-phase activity recognition module 300 is not interrupted while performing activity recognition. When the two-phase activity recognition module 300 completes activity recognition, the timer unit 130 releases the wake lock and switches the mobile device 100 to the sleep mode. The timer unit 130 then acquires a wake lock after a duration of time representing sleep time has elapsed. As stated above, in one embodiment, an adaptive sleep scheduling module 180 dynamically determines the duration of sleep time to conserve power.

The two-phase activity recognition module 300 is configured to dynamically vary the duration of awake time B based on user activity, thereby reducing power consumption of the two-phase activity recognition module 300 compared to using a fixed duration of awake time.

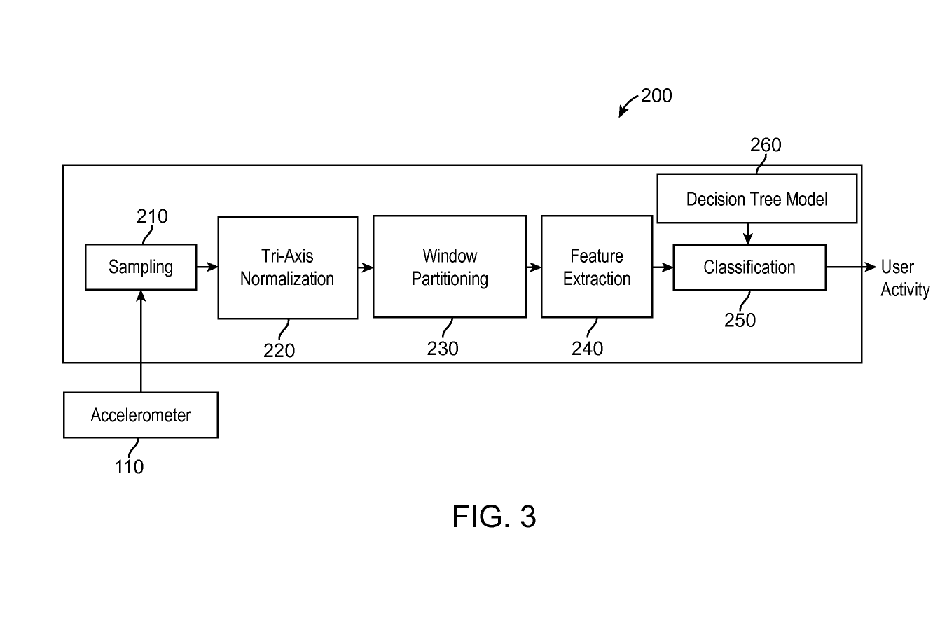

FIG. 3 shows a block diagram of an activity classifier module 200, in accordance with an embodiment. The two-phase activity recognition module 300 utilizes an activity classifier module 200 for identifying user activity (i.e., the activity of an end user of the mobile device 100). The activity classifier module 200 identifies user activity based on data captured by the sensors of the mobile device 100. The activity classifier module 200 comprises an accelerometer sampling unit 210, a tri-axis normalization unit 220, a window partitioning unit 230, a feature extraction unit 240, a decision tree classification unit 250, and a decision tree model 260.

The sampling unit 210 is configured to obtain samples of sensor data relating to current user activity from the sensors of the mobile device 100. In one embodiment, the sampling unit 210 obtains tri-axial accelerometer sample data from the accelerometer 110.

The tri-axis normalization unit 220 is configured to transform the tri-axial accelerometer sample data into three orientation-independent time series: (i) the Cartesian magnitude, (ii) the global vertical component of acceleration in the direction of gravity, and (iii) the component of acceleration on the global horizontal plane perpendicular to gravity.

The window partitioning unit 230 is configured to segment each time series into finite sampling windows, wherein the duration of each sampling window is determined by the two-phase activity recognition module 300.

The feature extraction unit 240 is configured to transform each sampling window into a feature vector including time-domain features and frequency-domain features. Examples of time-domain features include real-valued power and entropy. Examples of frequency-domain features include the highest magnitude frequency, the magnitude of the highest magnitude frequency, the weighted mean of the top five highest magnitude frequencies weighted by magnitude, and the weighted variance of the top five highest magnitude frequencies weighted by magnitude.

The decision tree classification unit 250 identifies user activity for each sampling window based on features extracted for the sampling window and the decision tree model 260. In one embodiment, the decision tree model 260 maintained in the mobile device 100 is generated offline in a training phase using training data including activity-labeled accelerometer data from multiple users.

In alternative embodiments, the steps involved in the activity classifier module 200 may be substituted with alternative techniques. For example, a different set of orientation-independent time series may be provided as input to the window partitioning unit 230. As another example, the feature extraction unit 240 extracts alternative time-domain features and frequency-domain features from each sampling window. As yet another example, alternative classification techniques such as support vector machines or neural networks may be used after creating classifier models using offline training.

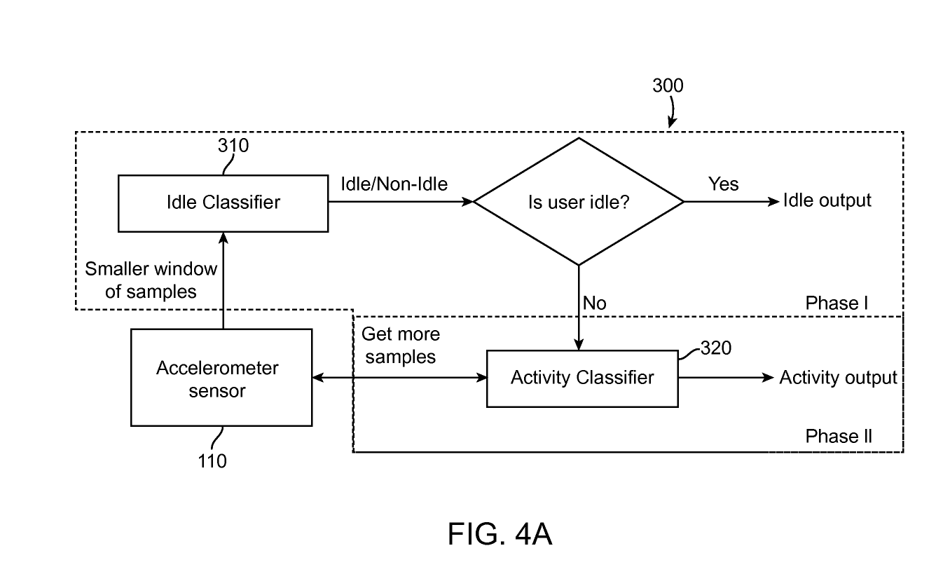

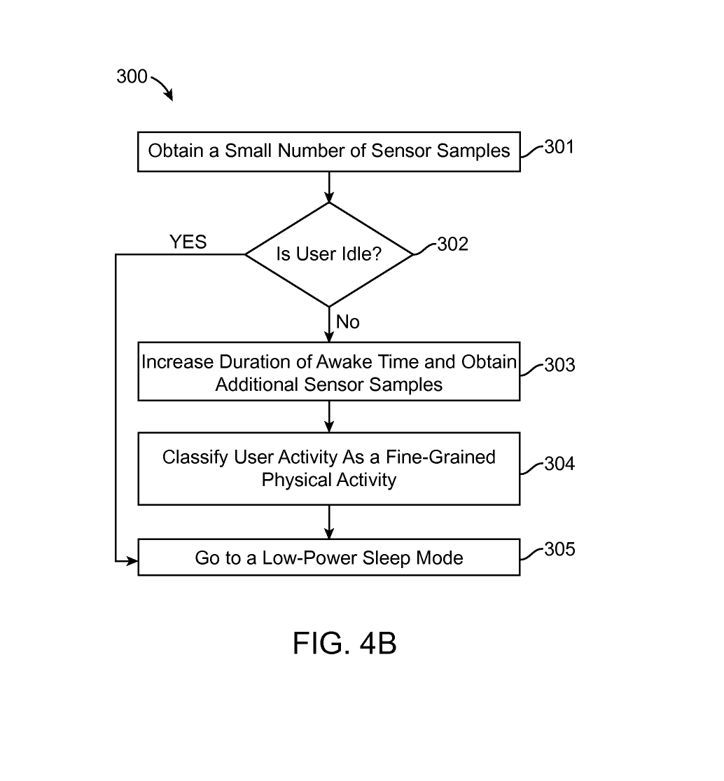

In one embodiment, the two-phase activity recognition module 300 maintains two instances of the activity classifier module 200, wherein each instance has its own corresponding decision tree model 260. Specifically, the two-phase activity recognition module 300 maintains a first instance of the activity classifier module 200 representing an idle classifier unit 310 (FIG. 4A), and a second instance of the activity classifier module 200 representing an activity classifier unit 320 (FIG. 4A).

The idle classifier unit 310 utilizes a small window of sensor sample data to determine whether an end user of the mobile device 100 is engaging in an idle activity or a non-idle physical activity. Idle activity encompasses user activity with little or no user movement, such as reading. The activity classifier unit 320 utilizes a larger window of sensor sample data to identify an actual physical activity that the end user is engaged in. Physical activity encompasses user activity involving at least moderate user movement, such as walking, biking, running, driving, etc.

FIG. 4A is a block diagram illustrating two-phase activity recognition, in accordance with an embodiment. As described above, in one embodiment, the two-phase activity recognition module 300 comprises an idle classifier unit 310 and an activity classifier unit 320. The idle classifier unit 310 classifies a user activity as an idle activity or a non-idle physical activity based on small sampling windows. The activity classifier unit 320 identifies an actual physical activity that the user is engaged in based on larger sampling windows. Idle activity encompasses user activity with little or no user movement, such as reading. Physical activity encompasses user activity involving at least moderate user movement, such as walking, biking, running, driving, etc.

In one embodiment, the two-phase activity recognition module 300 performs activity recognition in two phases. In a first phase Phase I, the two-phase activity recognition module 300 obtains a smaller-sized sampling window (e.g., a sampling window with a duration between 0.50 second and 1 second). The idle classifier unit 310 analyzes the smaller-sized sampling window to determine whether the user activity captured is idle activity or non-idle physical activity. If the user activity captured is idle activity, the two-phase activity recognition module 300 concludes that the user is idle, and notifies the timer unit 130 to switch the operational state of the mobile device 100 to the sleep mode. Therefore, the mobile device 100 immediately transitions to the sleep mode to conserve power when the two-phase activity recognition module 300 determines that the user is idle.

If the user activity captured in Phase I is non-idle physical activity, the two-phase activity recognition module 300 enters a second phase Phase II. In the second phase Phase II, the duration of awake time is extended so that the two-phase activity recognition module 300 may obtain additional sensor sample data for a larger-sized sampling window (e.g., a sampling window with a duration between 4 seconds and 8 seconds). The activity classifier unit 320 analyzes the larger-sized sampling window to determine the end user's fine-grained physical activity (e.g., walking, biking, idle etc.). Upon determining the actual physical activity that the user activity should be classified as, the two-phase activity recognition module 300 notifies the timer unit 130 to switch the operational state of the mobile device 100 to the low-power sleep mode.

In one embodiment, performing activity recognition in two phases reduces: (a) the percentage of time that the mobile device 100 is kept awake to perform activity recognition (“the wake time percentage”), and (b) the power consumption attributable to the two-phase activity recognition module 300 alone assuming that no other application is running on the mobile device 100. For example, based on a naturalistic accelerometer data collection effort totaling over 36 days from 8 subjects, an embodiment of a two-phase activity recognition module 300 that uses fixed durations of sleep time achieves 90% of the accuracy of an always-on activity recognition module. Further, compared to the always-on activity recognition module, the embodiment of the two-phase activity recognition module 300 that uses fixed durations of sleep reduces the wake time percentage and power consumption by 93.7% and 63.8%, respectively.

As another example, based on a naturalistic accelerometer data collection effort totaling over 36 days from 8 subjects, another embodiment of the two-phase activity recognition module 300 that uses adaptive durations of sleep time (e.g., set by the adaptive sleep scheduling unit 180) achieves 90% of the accuracy of an always-on activity recognition module. Further, compared to the always-on activity recognition module, the embodiment of the two-phase activity recognition module 300 that uses adaptive durations of sleep time reduces the wake time percentage and power consumption by 96.7% and 81.9%, respectively.

FIG. 4B illustrates an example flow chart 300 for activity recognition in a mobile device, in accordance with an embodiment. In process block 301, a small number of sensor samples are obtained from the mobile device. In process block 302, the sensor samples obtained are provided to an idle activity classifier to determine whether user activity (i.e., activity of an end user of the mobile device) is idle activity or non-idle physical activity. If the user activity is idle activity, output the idle activity, and proceed to process block 305 where the mobile device is placed in the low-power sleep mode, thereby ending duration of awake time for the mobile device.

If the user activity is non-idle physical activity, proceed to process block 303 where the duration of awake is increased and additional sensor samples are obtained. In process block 304, the additional sensor samples are provided to a physical activity classifier unit to classify the user activity as a fine-grained physical activity. After the user activity is classified, output the physical activity, and proceed to process block 305 where the mobile device is placed in the low-power sleep mode, thereby ending the duration of awake time for the mobile device.

FIG. 5 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices and/or networks, such as the Internet 550, a mobile electronic device 551, a server 552, and a network 553. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

The system 500 further includes an image capture device 520 such as a camera, an audio capture device 531 such as a microphone, a magnetometer module 535, an accelerometer module 532, a gyroscope module 533, and a light sensor module 534. The system 500 may further include application modules as MMS module 521, SMS module 522, email module 523, social network interface (SNI) module 524, audio/video (AV) player 525, web browser 526, image capture module 527, etc.

The system 500 further includes an activity recognition module 530 as described herein, according to an embodiment. In one embodiment, the activity recognition application module 530 along with an operating system 529 may be implemented as executable code residing in a memory of the system 500. In another embodiment, the activity recognition application module 530 along with the operating system 529 may be implemented in firmware.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. An activity recognition system for an electronic device, comprising:
at least one sensor configured to capture data relating to user activity; and
a two-phase activity recognition module configured to:
identify a user activity based on data captured by said at least one sensor; and
dynamically control power consumption of the activity recognition module based on the user activity identified.

2. The system of claim 1, further comprising:
a timer unit configured to:
switch an operational state of the electronic device between a first operating mode and a second operating mode;
wherein the second operating mode is a low power mode; and
wherein the electronic device consumes more power in the first operating mode than in the second operating mode.

3. The system of claim 2, wherein:
the two-phase activity recognition module identifies a user activity when the electronic device is in the first operating mode; and
the two-phase activity recognition module is further configured to dynamically vary a duration of the first operating mode to reduce power consumption for activity recognition.

4. The system of claim 3, wherein:
the two-phase activity recognition module is further configured to determine, in a first phase, whether a user activity based on data captured by said at least one sensor is either idle activity or physical activity.

5. The system of claim 4, wherein:
the operational state of the electronic device is switched to the second operating mode to conserve power if said user activity is idle activity.

6. The system of claim 4, wherein:
the two-phase activity recognition module is further configured to extend the duration of the first operating mode if said user activity is physical activity, such that said at least one sensor captures additional data for identifying said user activity.

7. The system of claim 5, wherein:
the two-phase activity recognition module is further configured to, in a second phase, classify said user activity as a type of physical activity based on additional data captured by said at least one sensor.

8. The system of claim 7, wherein:
a type of physical activity is one of walking, driving, biking or running.

9. The system of claim 2, further comprising:
an adaptive sleep scheduling unit configured to:
dynamically vary a duration of the second operating mode.

10. A method for facilitating activity recognition in an electronic device, comprising:
capturing data relating to user activity using at least one sensor device;
identifying a user activity based on data captured by said at least one sensor device; and
dynamically controlling power consumption for activity recognition based on the user activity identified.

11. The method of claim 10, further comprising:
switching an operational state of the electronic device between a first operating mode and a second operating mode;
wherein the second operating mode is a low power mode; and
wherein the electronic device consumes more power in the first operating mode than in the second operating mode.

12. The method of claim 11, further comprising:
identifying a user activity when the electronic device is in the first operating mode; and
dynamically varying a duration of the first operating mode to reduce power consumption for activity recognition.

13. The method of claim 12, further comprising:
determining whether a user activity based on data captured by said at least one sensor device is either idle activity or physical activity.

14. The method of claim 13, further comprising:
switching the operational state of the electronic device to the second operating mode to conserve power if said user activity is idle activity.

15. The method of claim 13, further comprising:
extending the duration of the first operating mode if said user activity is physical activity; and
capturing additional data using said at least one sensor device for identifying said user activity.

16. The method of claim 15, further comprising:
based on additional data captured by said at least one sensor device, classifying said user activity as a type of physical activity.

17. The method of claim 16, wherein:
a type of physical activity is one of walking, driving, biking, or running.

18. The method of claim 11, further comprising:
dynamically varying a duration of the second operating mode.

19. A non-transitory computer-readable medium having instructions which when executed on a computer perform a method comprising:
capturing data relating to user activity using at least one sensor;
identifying a user activity based on data captured by said at least one sensor; and
dynamically controlling power consumption for activity recognition based on the user activity identified.

20. The medium of claim 19, the method further comprising:
switching an operational state of the electronic device between a first operating mode and a second operating mode;
wherein the second operating mode is a low power mode; and
wherein the electronic device consumes more power in the first operating mode than in the second operating mode.

21. The medium of claim 20, the method further comprising:
identifying a user activity when the electronic device is in the first operating mode; and
dynamically varying a duration of the first operating mode to reduce power consumption for activity recognition.

22. The medium of claim 21, the method further comprising:
determining whether a user activity based on data captured by said at least one sensor is either idle activity or physical activity.

23. The medium of claim 22, the method further comprising:
switching the operational state of the electronic device to the second operating mode to conserve power if said user activity is idle activity.

24. The medium of claim 22, the method further comprising:
extending the duration of the first operating mode if said user activity is physical activity; and
capturing additional data using said at least one sensor for identifying said user activity.

25. The medium of claim 24, the method further comprising:
based on additional data captured by said at least one sensor, classifying said user activity as a type of physical activity.

26. The medium of claim 20, the method further comprising:
dynamically varying a duration of the second operating mode.

27. An electronic device, comprising:
at least one sensor configured to capture data relating to user activity; and
a two-phase activity recognition module configured to:
identify a user activity based on data captured by said at least one sensor; and
control power consumption of the activity recognition module based on the user activity identified.

28. The electronic device of claim 27, further comprising:
a timer unit configured to:
switch an operational state of the electronic device between a first operating mode and a second operating mode;
wherein the second operating mode is a low power mode;
wherein the electronic device consumes more power in the first operating mode than in the second operating mode; and
wherein the two-phase activity recognition module identifies a user activity when the electronic device is in the first operating mode.

29. The electronic device of claim 28, wherein:
the two-phase activity recognition module is further configured to dynamically vary a duration of the first operating mode by determining whether a user activity relating to data captured by said at least one sensor is either idle activity or physical activity;
wherein the operational state of the electronic device is switched to the second operating mode to conserve power if said user activity is idle activity; and
wherein the duration of the first operating mode is extended if said user activity is physical activity, such that said at least one sensor captures additional data relating to said user activity for classifying said user activity as a type of physical activity.

30. The electronic device of claim 28, further comprising:
an adaptive sleep scheduling unit configured to:
dynamically vary a duration of the second operating mode.
